(19) United States
(12) Patent Application Publication
(10) Pub. No.: US 2015/0319064 A1
(43) Pub. Date: Nov. 5, 2015

(54) PACKET COMMUNICATION METHOD AND DEVICE

(71) Applicant: HITACHI, LTD., Tokyo (JP)

(72) Inventors: Yuji OISHI, Tokyo (JP); Takashi ISOBE, Tokyo (JP); Takeki YAZAKI, Tokyo (JP)

(21) Appl. No.: 14/650,201

(22) PCT Filed: Oct. 25, 2013
(86) PCT No.: PCT/JP2013/078895

§ 371 Date: Jun. 5, 2015

(30) Foreign Application Priority Data
Feb. 12, 2013 (JP) 2013-023999

(51) Int. Cl. H04L 12/26; H04L 5/00; H04W 24/08

(52) U.S. Cl. CPC H04L 43/0829; H04W 24/08; H04L 5/0055

(57) ABSTRACT

An object of the present invention is to measure a packet loss rate by using information included in a general communication protocol. In a network including a transmission terminal, a communication line, and a reception terminal, the transmission terminal adds a number denoting a packet order to a transmission packet and transmits the transmission packet, and the reception terminal is a system using a protocol in which an order of packets, which have been received, is returned as an acknowledgement, and a system using a selective acknowledgement to notify of reception of discontinuous data when the reception terminal receives the discontinuous data. A method for measuring a packet loss rate by using a number of transmission packets and information on an acknowledgement and a selective acknowledgement is provided in the transmission terminal.

### TECHNICAL FIELD

The present invention relates to a packet communication method and a packet communication device.

### BACKGROUND ART

In cloud computing commonly known as cloud, a user uses a computer resource in an external data center, which is away from user's location. Data is also stored in the data center, and therefore data is frequently exchanged between user's location and the data center.

A data center is located around the world and is not necessarily always located in the same country. For example, a utility fee of an overseas data center is sometimes more inexpensive, and therefore the overseas data center is actively used.

Data might be transferred at low speed when an overseas data center is used. In communication with overseas, a round trip time (RTT) which is a time from transmitting a packet to receiving a response is long. In this case, there is a problem that a communication speed slows down in a general communication method.

With respect to this problem, in PTL 1, a high speed communication is realized by controlling a transmission data amount regardless of an RTT. In this method, the transmission data amount is controlled by monitoring a change in a packet loss rate. Also, in this method, information on such as a negative acknowledgement (NACK) transmitted and received between a transmitting device and a receiving device corresponding to this method is used for measuring the packet loss rate.

Also, a quality measurement packet is used as a method for measuring a packet loss rate in PTL 2. First, a receiving probe adds a packet reception counter to a quality measurement packet received from a transmission probe and returns the quality measurement packet to a transmission prove. Then, the transmission probe extracts a number of reception packets from the received quality measurement packet. A packet loss rate (packet discard rate) is calculated by calculating a difference between a packet transmission counter and a packet reception counter and a difference between the reception packet counter extracted and a packet return counter, after all quality measurement packets are received.

### CITATION LIST

### Patent Literature

PTL 1: WO 2012/066824 A1
PTL 2: JP 2008-85906 A

### Non-Patent Literature

NPL 1: IETF RFC 1122 “Requirements for Internet Hosts—Communication Layers” 4.2.3.2 When to Send an ACK Segment http://tools.ietf.org/html/rfc1122
NPL 2: IETF RFC 2018 “TCP Selective Acknowledgment Options” 3. Sack Option Format http://tools.ietf.org/html/rfc2018

### SUMMARY OF INVENTION

### Technical Problem

In PTL 1, a high speed communication is realized by controlling a transmission data amount by monitoring a change in a packet loss rate. However, communication terminals on a transmission side and a reception side need to respond to a communication method described in PTL 1, such as using a NACK for confirming data reception. However, not all communication terminals are corresponding to this communication method. Therefore, for example, a terminal using a general communication method as described in NPL 1 and NPL 2 is used in a communication. Therefore, it is necessary to measure a packet loss rate by using information obtained by a general communication method to control a transmission data amount based on a change in the packet loss rate in a communication with a terminal not corresponding to the communication method described in PTL 1.

Also, in the packet loss rate measurement method described in PTL 2, it is necessary to embed special information in a packet, and therefore both of a transmission terminal and a reception terminal need to correspond to the method. On the other hand, in the case where a communication partner is a general system, such information is not embedded, and therefore it is hard to measure an accurate loss rate.

An object of the present invention is to measure a packet loss rate by using information included in a general communication protocol.

### Solution to Problem

To achieve the above object, a communication device connected to a network is provided from one aspect of the present invention. The communication device includes: a transmission unit configured to transmit a packet to other communication device via the network; a reception unit configured to receive, from the other communication device via the network, an acknowledgement (ACK) packet including information on a selective acknowledgement (SACK) and information on an ACK with respect to a packet transmitted from the transmission unit; a packet counting unit configured to count a number of transmission packets, which is a number of packets transmitted from the transmission unit; and a loss rate measurement unit configured to measure a loss rate of a packet transmitted from the transmission unit in a predetermined period based on the number of transmission packets and information on the ACK and the SACK.

Preferably, the packet counting unit counts a number of retransmission request packets, which is a number of packets requested to be retransmitted in packets transmitted from the transmission unit, based on information on the ACK and the SACK, and the loss rate measurement unit measures the loss rate based on the number of transmission packets and the number of retransmission request packets.

Also, the packet counting unit counts a number of ACK packets, which is a number of ACK packets received by the reception unit, and a number of duplicate packets in ACK packets received by the reception unit, which is a number of the ACK packets in which information on the SACK corresponds to information on the SACK of an ACK packet received just before the ACK packet, and the loss rate measurement unit measures the loss rate based on the number of transmission packets, the number of ACK packets, and the number of duplicate packets.

Further preferably, the loss rate measurement unit changes a method for measuring a loss rate depending on a level of a loss rate.

According to other aspect of the present invention, a packet loss rate measuring method for measuring a loss rate of a packet transmitted from a communication device to a network is provided. The packet loss rate measuring method includes: measuring a number of transmission packets, which is a number of packets transmitted from the communication device to the network; and measuring a loss rate of a packet transmitted from the communication device to the network in a predetermined period based on the number of transmission packets and information on the SACK and an ACK included in an ACK packet received by the communication device via the network.

Further preferably, the packet loss rate measuring method includes: measuring a number of retransmission request packets, which is a number of packets requested to be retransmitted in packets transmitted to the network, based on information on the ACK and the SACK, and measuring a loss rate based on the number of transmission packets and the number of retransmission request packets.

Also, the packet loss rate measuring method includes: measuring a number of ACK packets, which is a number of ACK packets received by the communication device, and a number of duplicate packets in ACK packets received by the communication device, which is a number of ACK packets in which information on the SACK corresponds to information on the SACK of an ACK packet received just before the ACK packet; and measuring the loss rate based on the number of transmission packets, the number of ACK packets, and the number of duplicate packets.

Further preferably, a method for measuring a loss rate is changed depending on a level of a loss rate.

### Advantageous Effects of Invention

According to the present invention, an accurate packet loss rate can be measured even if a general communication protocol is used.

### BRIEF DESCRIPTION OF DRAWINGS

FIG. 1 is a functional block diagram of a transmission terminal according to the present invention.

FIG. 2 is a hardware configuration diagram of a transmission terminal according to a first embodiment of the present invention.

FIG. 3 is a functional block diagram of the transmission terminal according to the first embodiment of the present invention.

FIG. 4 illustrates an example of a communication sequence according to the first embodiment of the present invention.

FIG. 5 illustrates a packet format of a SACK.

FIG. 6 is a flowchart of a packet counting unit according to the first embodiment of the present invention.

FIG. 7 is a hardware configuration diagram of a proxy device according to the present invention.

FIG. 8 is a functional block diagram of the proxy device according to the present invention.

FIG. 9 illustrates a communication sequence according to a second embodiment of the present invention.

FIG. 10 is a functional block diagram of a transmission terminal according to the second embodiment of the present invention.

FIG. 11 is a flowchart of a packet counting unit according to the second embodiment of the present invention.

FIG. 12 is a flowchart of a loss rate calculation unit according to a third embodiment of the present invention.

FIG. 13 is a flowchart of a packet counting unit according to the third embodiment of the present invention.

FIG. 14 is a functional block diagram of a transmission terminal according to a fourth embodiment of the present invention.

FIG. 15 is a flowchart of a packet counting unit according to the fourth embodiment of the present invention.

FIG. 16 is a functional block diagram of a transmission control unit according to a fifth embodiment of the present invention.

FIG. 17 is a flowchart of the transmission control unit according to the fifth embodiment of the present invention.

### DESCRIPTION OF EMBODIMENTS

### First Embodiment

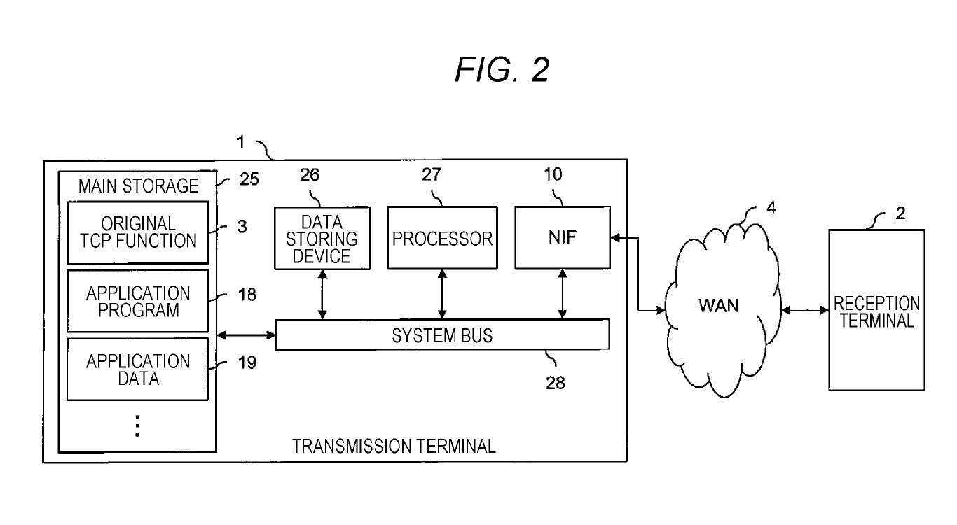

FIG. 2 is a system configuration diagram and a hardware configuration diagram of a transmission terminal 1 according to a first embodiment of the present invention. The transmission terminal 1 at least includes a network interface (hereinafter called a NIF) 10, a main storage 25, a data storing device 26, a processor 27, and a system bus 28. The main storage 25 temporarily stores a program and data to read and write the data. The data storing device 26 stores a program and data for a long period and loads them to the main storage 25 as necessary. The processor 27 executes the program on the main storage 25, processes the data on the main storage 25, and writes a result in the main storage 25. The system bus 28 connects them each other and transfers the data. The main storage 25 stores such as an original TCP function 3, an application program 18, and application data 19. The application program 18 is executed by the processor 27 by using the application data 19, and transmission data is controlled by using the original TCP function 3. The original TCP function 3 transmits the above transmission data to the NIF 10, and the NIF 10 transmits the transmission data to a WAN 4. Although FIG. 2 illustrates an example that the original TCP function 3 is totally configured by software, the original TCP function 3 can be applied by mounting a part of or all of the original TCP function 3 to the processor 27 or the NIF 10.

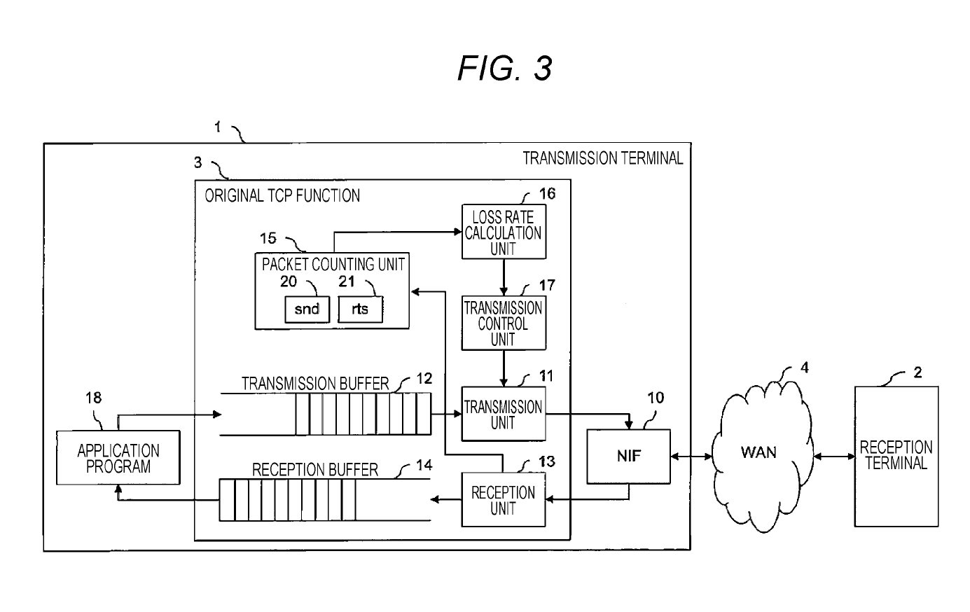

FIG. 3 is a functional block diagram regarding transmission/reception of data and a packet loss rate measuring function 3 in the transmission terminal 1 according to the first embodiment of the present invention. The transmission terminal 1 includes the NIF 10, the application program 18, and the original TCP function 3. The original TCP function 3 further includes a transmission unit 11, a transmission control unit 17, a transmission buffer 12, a reception unit 13, a reception buffer 14, a packet counting unit 15 and a loss rate calculation unit 16. The transmission unit 11 transmits data from the NIF 10 to the WAN 4. The transmission control unit 17 controls an amount and an order of data transmitted from the transmission unit 11. The transmission buffer 12 temporarily buffers data transmitted from the application program 18, holds the data to retransmit when a packet is discarded, and transmits necessary data to the transmission unit. The reception unit 13 receives data transmitted from the WAN 4 to the NIF 10. The reception buffer 14 confirms consistency of such as an order of data received by the reception unit 13 and transmits the data to the application program 18.

Also, a number of transmission packets is counted by a snd counter 20 in the packet counting unit. The packet counting unit 15 analyzes information on a received ACK and a SACK associated with the ACK, and an rts counter 21 counts a number of packets requested to be retransmitted (a number of discarded packets).

Based on the value, the loss rate calculation unit 16 calculates a loss rate as loss_ratio=rts/snd by using a number of transmission packets snd and a number of retransmission request packets rts. This calculation is performed at arbitrary intervals. After calculation, the snd counter 20 and the rts counter 21 are set to 0. A calculation result of the loss rate is transmitted to the transmission control unit 17 and a transmission data amount is adjusted.

As another calculation method, since a number of ACK packets ack indicates a number of accurately received packets, a loss rate can be set as a value subtracting a rate of accurately received packets from 1 and calculated as loss_ratio=1−ack/snd. However, according to RFC 1122 (NPL 1), ACK packets can be transmitted while being thinned out. Therefore, this calculation method does not always accurately calculate in the case where ACK packets are transmitted while being thinned out.

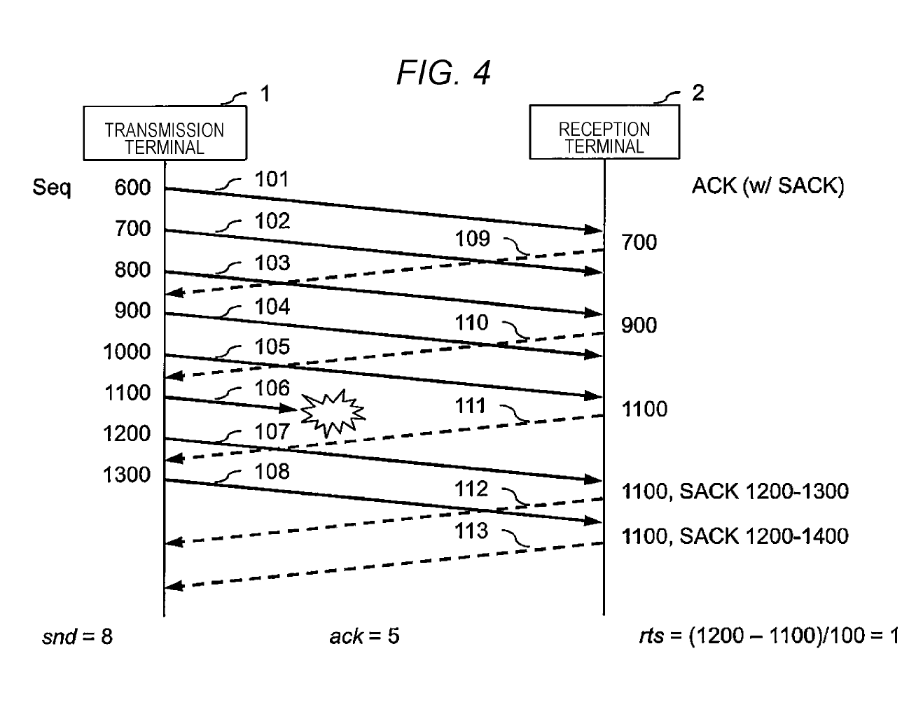

FIG. 4 illustrates an example of a communication sequence according to the first embodiment of the present invention. Herein TCP is assumed to be used. However, it is not necessarily used in a method using an ACK. The transmission terminal 1 transmits a packet with a sequence number “600” (101). Since a packet has been accurately received, the reception terminal 2 notifies, as an ACK, the transmission terminal 1 of an ACK number “700” as a sequence number to be received next (109).

The transmission terminal 1 transmits a packet with a sequence number “700” (102) and a packet with a sequence number “800” (103) before the ACK is returned, and these packets are also accurately received by the reception terminal 2. Herein, the reception terminal 2 uses a delayed ACK specified in RFC 1122, and an ACK is transmitted while being thinned out. Therefore, the reception terminal 2 does not transmit an ACK even if it receives the packet with a sequence number “700”. The reception terminal 2 transmits an ACK number “900” (110) when it receives a packet with a sequence number “800”, Regarding packets with sequence numbers “900” (104) and “1000” (105), the reception terminal 2 also transmits an ACK number “1000” (111).

It is assumed that a following packet with a sequence number “1100” (106) is discarded in a network. This packet is not received by the reception terminal 2. Furthermore, a subsequent packet with a sequence number “1200” (107) is accurately received, and packets held by the reception terminal 2 have omissions. In such a case, according to RFC 2018 (NPL 1), the reception terminal 2 transmits a SACK which is a selective acknowledgement. The SACK is information associated with an ACK and indicates a starting edge and a terminal edge of discontinuous packets in the packets held by the reception terminal 2. Herein, in addition to an ACK number “1100”, a SACK block “1200-1300” is notified to the transmission terminal 1 (112).

Then, when the reception terminal 2 receives a packet with a sequence number “1300” (108), an ACK number “1100” and a SACK block “1200-1400” are notified to the transmission terminal 1 (113). The transmission terminal 1 can know a packet discarded in a network by this SACK and retransmits only the packet.

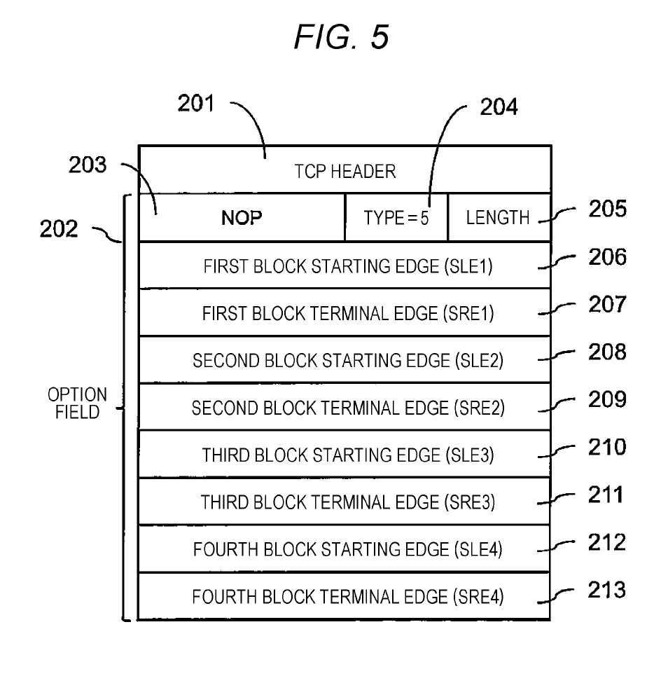

FIG. 5 illustrates a packet format of a SACK. The SACK is added to an option field 202 of a TCP header 201 and specifies a starting edge (SACK left edge: SLE) 206 and a terminal edge (SACK right edge: SRE) 207 of a first block following a type 204 and a length 205 across no operation (NOP) 203 which indicates not operating. In the case where multiple blocks are notified, subsequent SACK left edges 208, 210, and 212 and SACK right edges 209, 211, and 213 are specified as well. By limiting an option length, four blocks can be transmitted at a maximum. In the case where multiple packets have been discarded, multiple SACK blocks are notified. Regarding a SACK block which has been notified, latest four blocks are notified.

If a subsequent packet is accurately received after a SACK is generated, SACK right edges of the SACK block increase. On the other hand, when a subsequent packet is discarded, another SACK block is newly notified in addition to the SACK block. This is called a new SACK block. Conversely, in the case where the new SACK block is notified, it means a loss occurs. Specifically, when the new SACK block is notified, a difference from a value of a SACK left edge to a value closest to either an ACK which has been notified or a SACK right edge a SACK block is a segment number of discarded packets. A number of discarded packets is a value dividing the number of segments by a packet size.

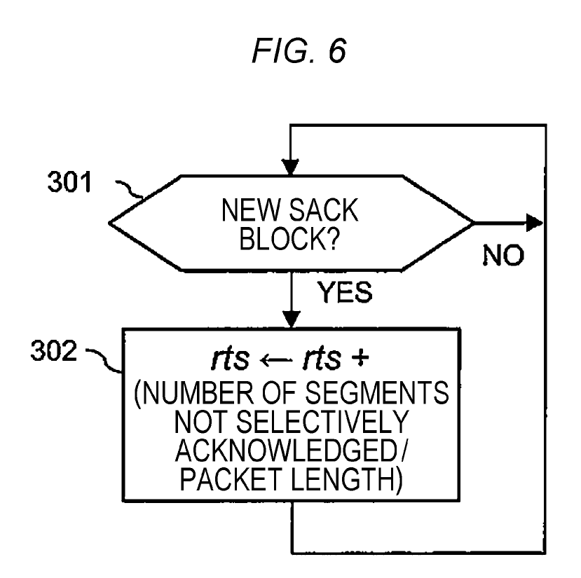

FIG. 6 is a processing flowchart of a packet counting unit according to the first embodiment of the present invention. When the packet counting unit receives a new SACK block (301), the packet counting unit calculates a number of discarded packets by the above-described method and counts up its (302).

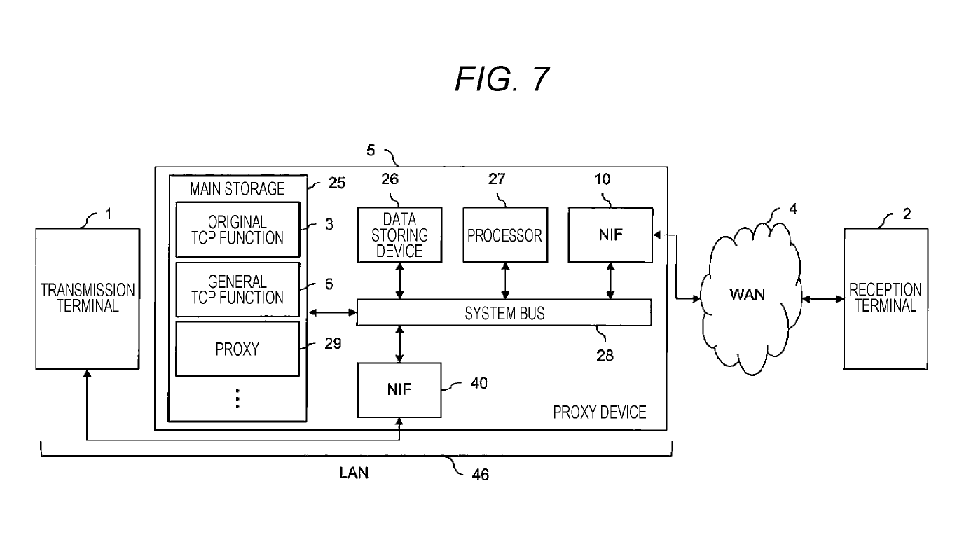

Although the embodiment illustrates an example that the original TCP function 3 is incorporated into the transmission terminal 1, in the case where the original TCP function 3 cannot be mounted to the transmission terminal 1, a proxy device 5 including the original TCP function 3 in a local area network (LAN) 46, which is the same as a LAN of the transmission terminal 1, can be installed and used as illustrated in FIG. 7. FIG. 7 is a hardware configuration diagram of a proxy device 5. A difference from a case where the original TCP function 3 is included in the transmission terminal 1 is that a NIF 40 for the LAN 46 is added to connect to the transmission terminal 1. Although FIG. 7 also illustrates an example that the original TCP function 3 is totally configured by software, the original TCP function 3 can be used by mounting a part of or all of the original TCP function 3 to the processor 27 or the NIF 10.

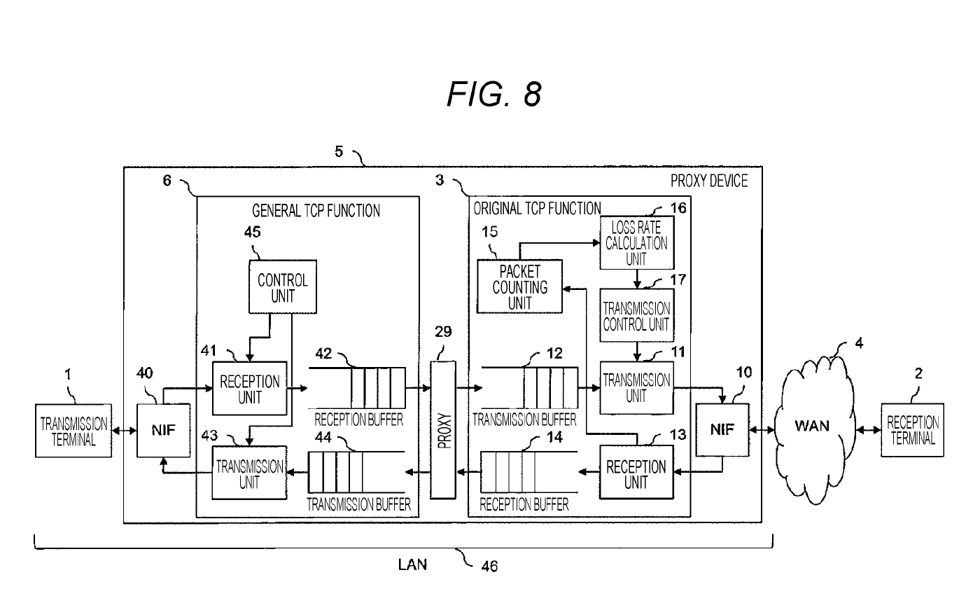

FIG. 8 illustrates a functional block diagram of the above-described proxy device. The proxy device 5 includes the LAN side NIF 40, the NIF 10, the original TCP function 3, and a proxy 29. The NIF 10 is connected to a general TCP function 6 for communicating with the transmission terminal 1 and the WAN 4. The original TCP function 3 communicates with the reception terminal 2 via the WAN 4. The proxy 29 transfers data between buffers of the original TCP function 3 and the general TCP function 6.

In the embodiment and following embodiments, only the case where the original TCP function 3 is incorporated into the transmission terminal 1 is described to simplify a description. However, similar effects can be obtained in the case where a proxy device is used by using the same elements as used in each embodiment in the original TCP function 3.

### Second Embodiment

A second embodiment is assumed that a packet loss rate is high, and a large amount of SACK blocks generates. In this case, if further packet loss occurs during reception of a new packet by the reception terminal 2, a new SACK block is generated. However, in general mounting, a storage area of a SACK block is limited in capacity, and the capacity reaches a limit at a certain quantity. Two operation patterns can be considered as such a case. One is that the reception terminal 2 does not return an ACK, and another is that all SACK blocks are not changed although an ACK with a SACK is returned.

Also, in the case where the number of SACK blocks falls below a certain number by retransmitting a part of packets when the number of SACK blocks reaches a limit, new packets which have been sent are discarded since the number of SACK blocks reaches a limit. However, new packets which have been sent afterward are received since a new SACK block can be made, and a new SACK block is generated. At this time, a value calculated as an rts becomes considerably large in a method according to the first embodiment. In the case where a calculation is performed at a certain interval, a loss generated in a previous section is calculated as an rts in this interval, and therefore an rts might exceed a snd. Therefore, an accurate loss rate cannot be measured.

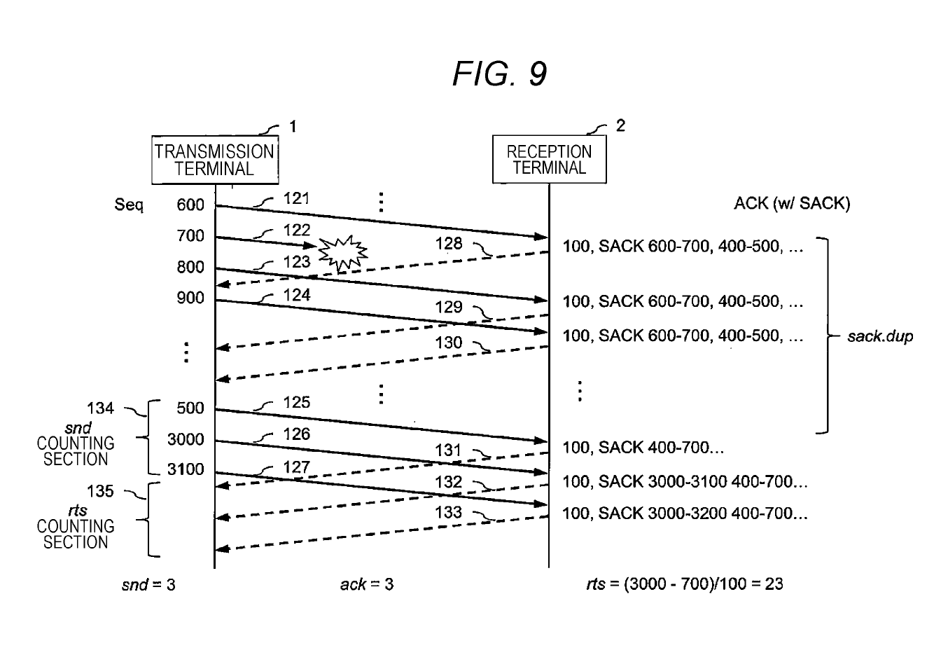

FIG. 9 illustrates a communication sequence according to the second embodiment of the present invention. Although the reception terminal 2 returns an ACK with a SACK, all SACK blocks indicate an unchanged state. Although the transmission terminal 1 transmits a packet with a sequence number “600” to the reception terminal 2 (121), a large amount of packets already have been discarded when earlier packets have been transmitted, and the reception terminal 2 is assumed to notify the transmission terminal 1 of an ACK number “100” and SACK numbers “400-500, . . . ”. Also, at a point when a packet with a sequence number “600” (121) is received, a loss storage area of the reception terminal 2 is assumed to reach a limit. The reception terminal 2 notifies the transmission terminal 1 of the ACK number “100” and SACK numbers “600-700, 400-500, . . . ” (128).

The transmission terminal 1 transmits a packet with a sequence number “700” in the time between (122). This packet is discarded in a network. Also, the transmission terminal 1 transmits a packet with a sequence number “800” (123), and the packet reaches the reception terminal 2. Although a new SACK block is supposed to be generated, a storage area of a SACK block has a limit in capacity, and therefore the reception terminal 2 cannot hold a new SACK block, and notifies the transmission terminal 1 of an ACK number “100” and SACK numbers “600-700, 400-500, . . . ” with the previous ACK packet (129). Equivalent ACK and SACK are returned with respect to a packet with a sequence number “900” (124) (130). After that, packets by a sequence number “2900” are supposed to be sent and wholly discarded in the reception terminal 2.

Then, the transmission terminal 1 retransmits a packet with a sequence number “500” (125). In this manner, the SACK blocks of “400-500” and “600-700” are connected each other and become the new SACK block “400-700”, and this is notified (131). A number of SACK blocks held by the reception terminal 2 is reduced, and therefore a new packet can be received.

At this point, the transmission terminal 1 transmits a new packet “3000” (126). The reception terminal 2 receives the new packet, and new SACK block “3000-3100” are notified (132). A packet with a sequence number “3100” (127) is also correctively received, and a SACK number “3000-3200” is returned (133).

Herein, as illustrated in FIG. 9, a snd count section (134) and an rts count section (135) are set for each RTT. At this time, although a snd becomes snd=3, an rts becomes rts=(3000−700)/100=23 by a value of a newly received SACK, and a calculation value of a loss rate becomes more than 1 in the method according to the first embodiment. However, in the case of calculating at other section in the same way, although a snd becomes snd=3, an rts becomes rts=0 since a new SACK block is not notified. Therefore, a loss rate is calculated as 0 even though a reception terminal does not receive a packet.

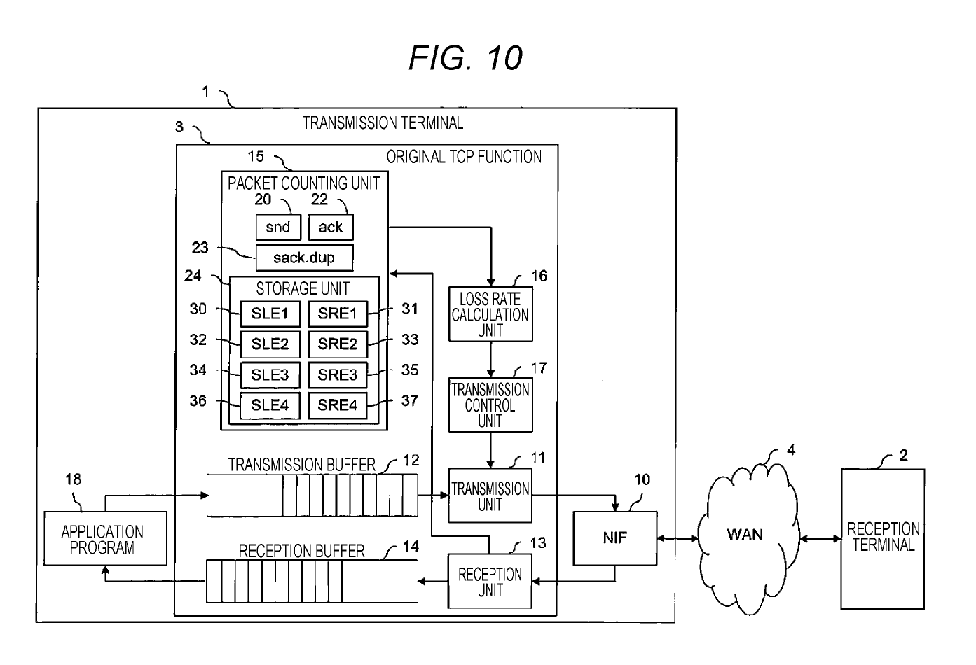

In the second embodiment, a configuration illustrated in a functional block diagram in FIG. 10 is applied to respond to the above issue. A different point from the first embodiment is that an rts counter 21 to count a number of retransmission requests is removed from a counter of the packet counting unit 15, an ack counter 22 to count a number of ACK packets, a sack.dup counter 23 to count a number of ACK packets in which information of SACK blocks are totally duplicated, and a storage unit 24 for storing a SACK block in a previous ACK packet are newly added to the packet counting unit 15. The storage unit 24 stores SACK left edges (SLE1 to 4) 30, 32, 34, and 36 of first to fourth blocks and SACK right edges (SRE1 to 4) 31, 33, 35, and 37 of the first to fourth blocks.

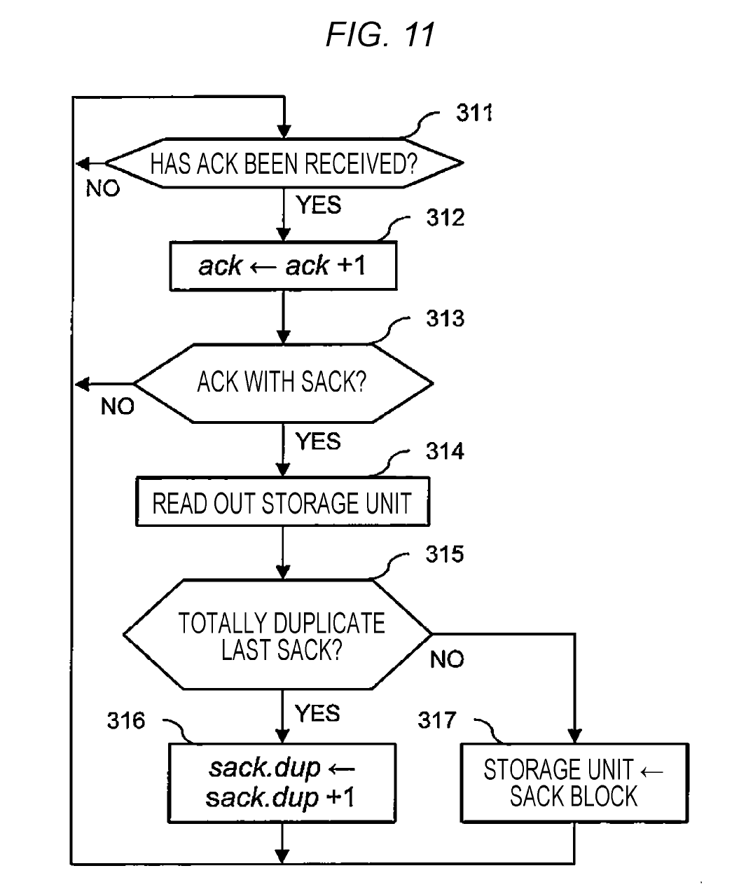

FIG. 11 is a flowchart of the packet counting unit 15 according to the second embodiment of the present invention. Each time an ACK is received (311), an ack increases one (312). In the case of a packet with a SACK (313), a value of a previously received SACK is read out from the storage unit 24 (314). If all SACK values are equal to a value of the SACK which has been previously received (315), sack.dup increases 1 (316). Otherwise, the value of a SACK block is recorded to the previous SACK block (317) and the packet counting unit 15 returns to top.

A loss rate calculation unit 16 calculates a loss rate based on a result of the value. The loss rate is calculated as a value subtracting a rate of accurately received packets from 1. However, packets discarded in a reception terminal are not received due to a limit of a storage capacity, and therefore the packets are excluded from a number of accurately received packets. Therefore, a loss rate is calculated as loss_ratio=1−(ack−sack.dup)/snd. This calculation formula responds to both of a case that an ACK is not returned and a case that all SACK blocks does not change although an ACK with SACK is returned.

### Third Embodiment

In the second embodiment, it has been described that the method according to the first embodiment has not been suitable when a loss rate has been high. On the other hand, the method according to the second embodiment is not suitable when a loss rate is low. This is because, although ACK packets can be thinned and transmitted according to the RFC 1122, a loss rate is calculated by using a number of ACK packets in the method described in the second embodiment, and the loss rate cannot be accurately calculated if the ACK packets are thinned out.

Therefore, it is effective to switch these formulas to accurately measure a loss rate during either a low loss rate or a high loss rate. A relation among a number of transmission packets snd and a number of ACK packets ack, and a number of retransmission request packets rts is supposed to be snd=ack+rts. Therefore, for example, the formula is switched based on this relation.

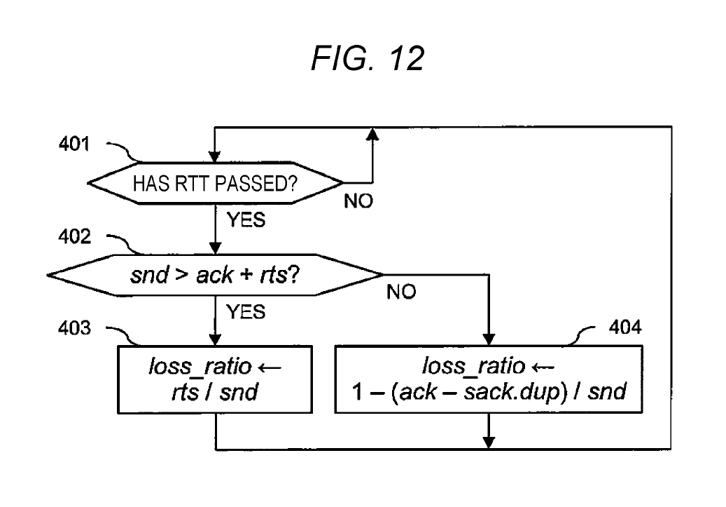

FIG. 12 is a flowchart of the loss rate calculation unit 16 according to a third embodiment of the present invention. A loss rate is calculated for each RTT (401). At a low loss rate, an ACK packet is thinned out by RFC 1122, and the relation becomes snd>ack+rts. Therefore, in the case of snd>ack+rts (402), a loss rate is calculated as loss_ratio=rts/snd as is the case with the first embodiment (403). On the other hand, at a high loss rate, although an ACK is not thinned out, an rts value is sometimes larger than a snd, and therefore the relation becomes snd<=ack+rts. This case is calculated as loss_ratio=1−(ack−sack.dup)/snd (404) as is the case with the second embodiment.

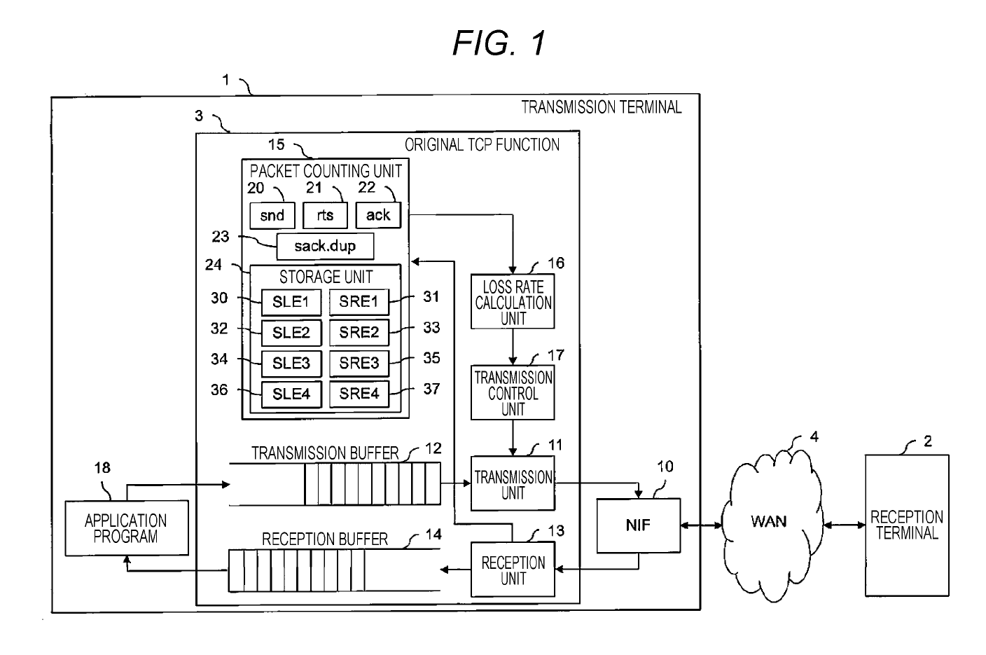

FIG. 1 is a functional block diagram according to the third embodiment of the present invention. A different point from the second embodiment is that an rts counter 21 is added to the packet counting unit 15.

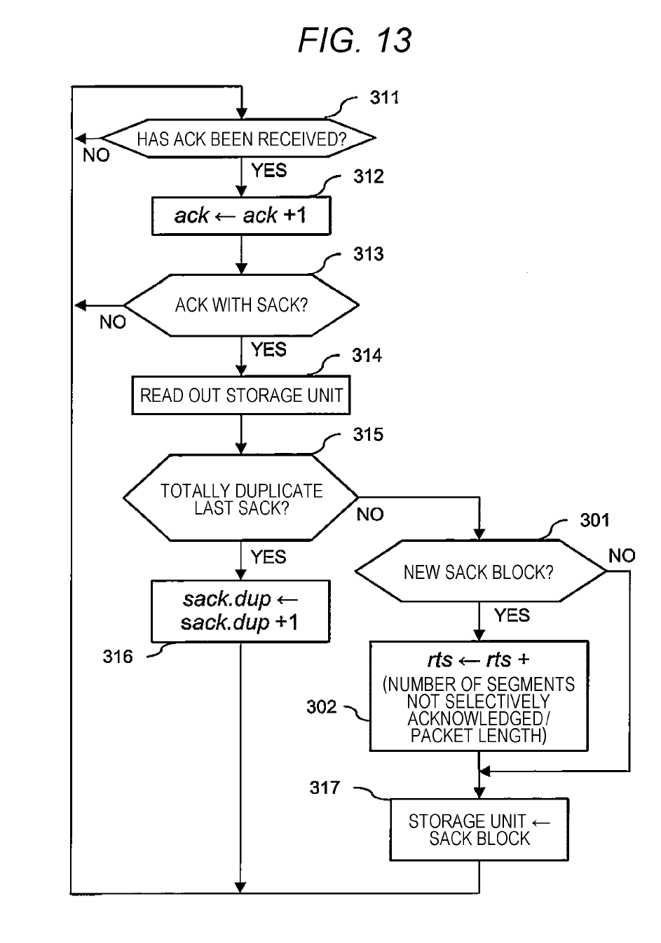

FIG. 13 is a flowchart of the packet counting unit 15 according to the third embodiment of the present invention. This is combined with flowcharts of the first embodiment and the second embodiment. Each time an ACK is received (311), an ack increases one (312). In the case of a packet with a SACK (313), a value of a previously received SACK is read out from the storage unit 24 (314). If all SACK values are equal to a value of the SACK which has been previously received (315), sack.dup increases 1 (316). Otherwise, it is determined whether or not to be a new SACK block (301), and in the case of a new SACK block, a number of lost packets is calculated by “a segment number of packets not selectively acknowledged, that is, not confirmed reception/packet length” and an its is counted up (302). A value of the SACK block is stored in the storage unit 24 (317), and the packet counting unit 15 returns to top.

### Fourth Embodiment

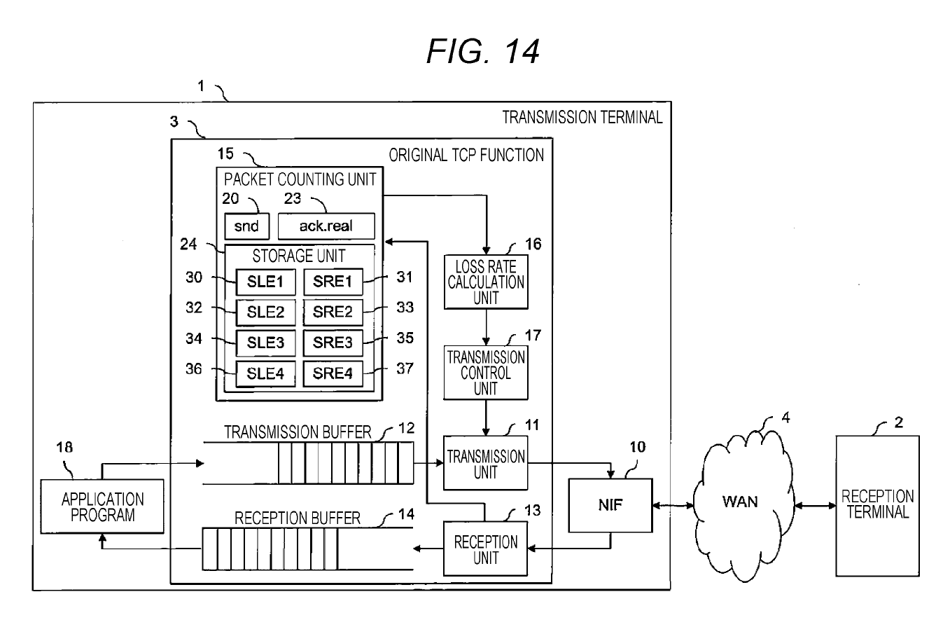

As a method for accurately measuring a loss rate in a unified method in comparison with the first to the third embodiments, there is a method to count a number of segments newly confirmed reception by an ACK or a SACK. FIG. 14 is a functional block diagram in this case. A different point from the first to third embodiments is that a snd counter 20 and an ack.real counter 23 which counts a number of packets actually acknowledged or selectively acknowledged are applied as a counter of the packet counting unit 15. Also, a storage unit 24 which stores a previous SACK block is included.

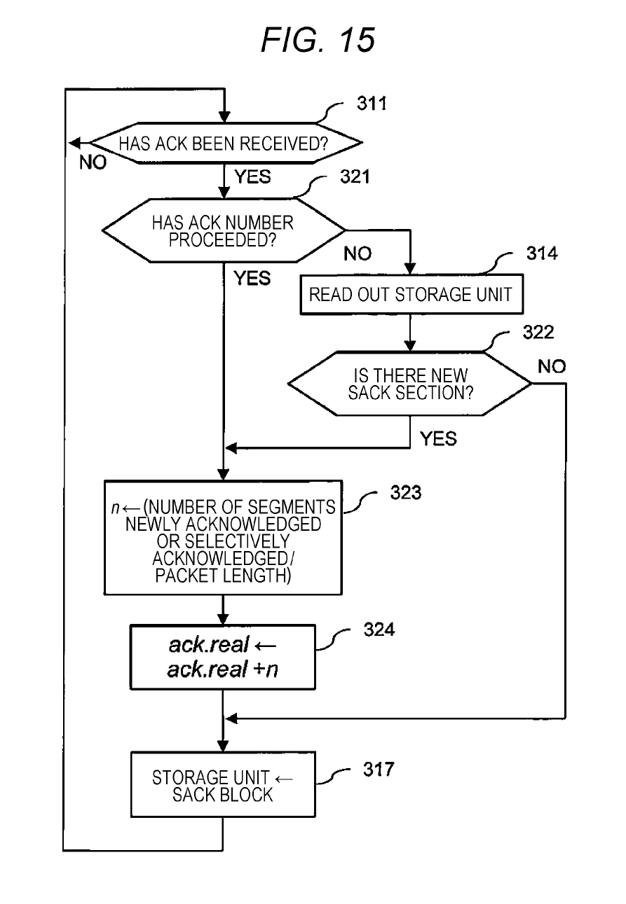

FIG. 15 is a flowchart of the packet counting unit 15 according to the fourth embodiment of the present invention. A packet counting unit 15 determines whether an ACK number advances every time the packet counting unit 15 receives an ACK (311) (321). If the number is not advancing, the packet counting unit 15 reads out a value of a previously received SACK from the storage unit 24 (314) to determine whether a starting edge number in a SACK block is reduced, a terminal edge number is increased, or two blocks or more are not connected each other (322). In the case where an ACK or a SACK shows a change, the segment number is calculated and divided by a packet length, and a number of packets newly received by a reception terminal 2 is calculated (323). This value is added up to ack.real (324). A value of the SACK block is stored in the storage unit 24 and the packet counting unit 15 returns to a beginning (317).

A loss rate calculation unit 16 calculates a loss rate as loss_ratio=1−ack.real/snd.

In this method, a loss rate can be accurately measured by a unified method in comparison with the first to third embodiments. Therefore, this method is effective when a transmission terminal 1 has a sufficient computing performance.

### Fifth Embodiment

### A Band Control Method by Using the Above Loss Rate Measuring Method

A method for controlling a transmission band by using a loss rate calculated in any of the first to fourth embodiments is described in a fifth embodiment. Also, the method according to the embodiment can be applied in the case where an original TCP function 3 is incorporated in a transmission terminal 1 and in the case where a proxy device 5 is used.

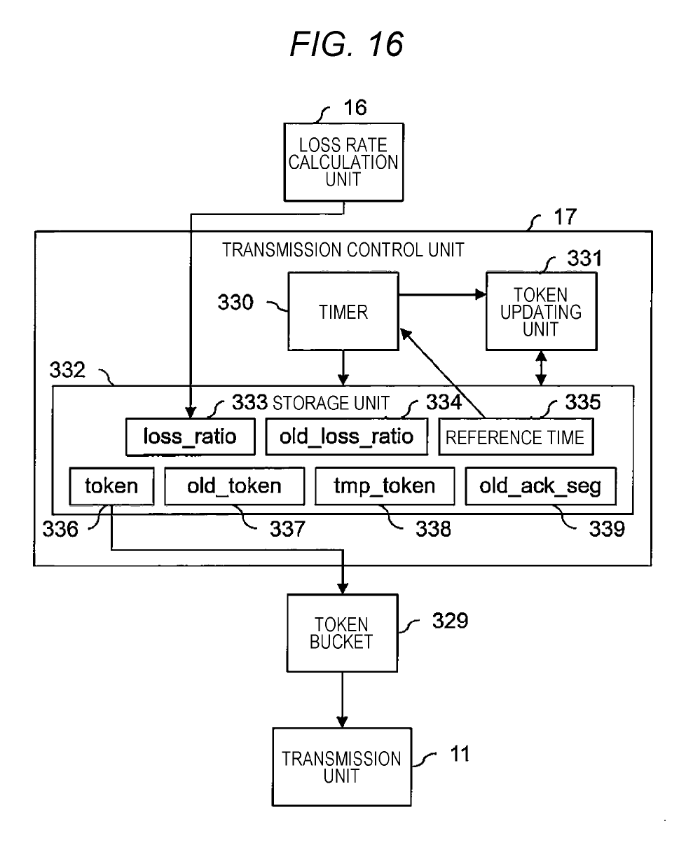

FIG. 16 is a functional block diagram of a transmission control unit 17. According to the embodiment, transmission is controlled by token bucket algorithm. In the token bucket algorithm, a token amount determined per unit time is accumulated in a token bucket, and a packet can be transmitted when the amount reaches a transmission packet length. When a packet is transmitted, a token of a packet length is reduced from the token bucket.

Therefore, the transmission control unit 17 includes a token bucket 329 and a timer 330, and also a storage unit 332 for storing values necessary for calculating a token and a token updating unit 331 for calculating a token. The storage unit includes a loss_ratio storage unit 333, an old_loss_ratio storage unit 334, a reference time storage unit 335, a token storage unit 336, an old_token storage unit 337, a tmp_token storage unit 338, and an old_ack_seg storage unit 339. The loss_ratio storage unit 333 holds a loss rate calculated by the loss rate calculation unit 16. The old_loss_ratio storage unit 334 stores a loss_ratio rate before a token is updated. The reference time storage unit 335 stores a reference time of a next token updating time. The token storage unit 336 stores a current token value. The old_token storage unit 337 stores a token value before a token is updated. The tmp_token storage unit 338 temporarily stores a token value when the value is transferred to an old_token. The old_ack_seg storage unit 339 stores an ACK number before a token is updated.

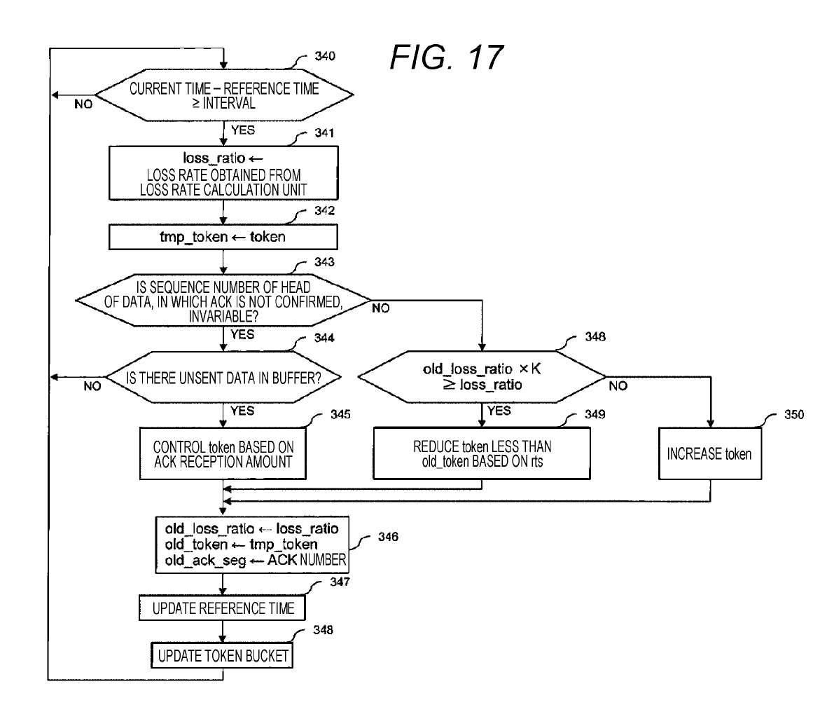

FIG. 17 is a flowchart illustrating an operation of the transmission control unit 17. First, the transmission control unit 17 determines by the timer 330 whether a difference between a current time and a reference time is larger than a predetermined interval (340). As an interval, a calculated RTT may be used. When the difference between a current time and a reference time is larger than the interval, a loss rate obtained by the loss rate calculation unit 16 is stored in a loss_ratio (341). Also, a token value is saved in a tmp_token (342).

Next, the transmission control unit 17 checks whether a top of sequence number of ACK unconfirmed data is changed (343). In the case that the number has been changed, the transmission control unit 17 checks whether unsent data is stored in a buffer (344), and a token is set to an ACK reception amount if unsent data is stored.

If a sequence number has advanced in 343, the transmission control unit 17 checks whether K times of old_loss_ratio is larger than a loss_ratio with respect to a predetermined constant K which is equal to or greater than 1 (348). If it has been larger, a token is reduced so as to be lower than an old_token based on an rts. For example, token←old_token-rts (349). In 348, if K times of old_loss_ratio is smaller than a loss_ratio, a token is increased by an arbitrary amount (350).

After 345, 349, and 350, a loss_ratio is substituted for an old_loss_ratio, a tmp_token is substituted for an old_token, and a current ACK number is substituted for an old_ack_seg (346), and a reference time is updated (347) and a token bucket 329 is updated (348).

### REFERENCE SIGNS LIST

1 transmission terminal
2 reception terminal
3 original TCP function
4 WAN
5 proxy device
6 general TCP function
10 NIF
11 transmission unit
12 transmission buffer
13 reception unit
14 reception buffer
15 packet counting unit
16 loss rate calculation unit
17 transmission control unit
20 transmission packet counter
21 retransmission request packet counter
22 ACK packet counter
23 duplicate SACK packet counter
24 storage unit
25 actually received packet counter
29 proxy
40 LAN side NIF
41 LAN side reception unit
42 LAN side reception buffer
43 LAN side transmission unit
44 LAN side transmission buffer
45 LAN side control unit
46 LAN

1. (canceled)

2. (canceled)

3. A communication device connected to a network, comprising:
a transmission unit configured to transmit a packet to other communication device via the network;
a reception unit configured to receive, from the other communication device via the network, an ACK packet including information on a SACK and information on an ACK with respect to a packet transmitted from the transmission unit;
a packet counting unit configured to count a number of transmission packets, which is a number of packets transmitted from the transmission unit; and
a loss rate measurement unit configured to measure a loss rate of a packet transmitted from the transmission unit in a predetermined period based on the number of transmission packets and information on the ACK and the SACK,
wherein
the packet counting unit counts a number of ACK packets, which is a number of ACK packets received by the reception unit, and a number of duplicate packets in ACK packets received by the reception unit, which is a number of the ACK packets in which information on the SACK corresponds to information on the SACK of an ACK packet received just before the ACK packet, and
the loss rate measurement unit measures the loss rate based on the number of transmission packets, the number of ACK packets, and the number of duplicate packets.

4. A communication device connected to a network, comprising:
a transmission unit configured to transmit a packet to other communication device via the network;
a reception unit configured to receive, from the other communication device via the network, an ACK packet including information on a SACK and information on an ACK with respect to a packet transmitted from the transmission unit and;
a packet counting unit configured to count a number of transmission packets, which is a number of packets transmitted from the transmission unit; and a loss rate measurement unit configured to measure a loss rate of a packet transmitted from the transmission unit in a predetermined period based on the number of transmission packets and information on the ACK and the SACK,
wherein the loss rate measurement unit changes a method for measuring the loss rate in a case where the ACK packet is not returned, in a case where a SACK packet is not changed, or in a case where an ACK packet is transmitted while being thinned out.

5. A communication device connected to a network, comprising:
a transmission unit configured to transmit a packet to other communication device via the network;
a reception unit configured to receive, from the other communication device via the network, an ACK packet including information on a SACK and information on an ACK with respect to a packet transmitted from the transmission unit;
a packet counting unit configured to count a number of transmission packets, which is a number of packets transmitted from the transmission unit; and
a loss rate measurement unit configured to measure a loss rate of a packet transmitted from the transmission unit in a predetermined period based on the number of transmission packets and information on the ACK and the SACK,
wherein
the packet counting unit counts a number of ACK packets, which is a number of ACK packets received by the reception unit, and a number of retransmission request packets, which is a number of packets requested to be retransmitted in packets transmitted from the transmission unit based on information on the ACK and the SACK, and
the loss rate measurement unit changes a method for measuring the loss rate depending on a relation among the number of transmission packets, the number of retransmission request packets, and the number of ACK packets.

6. The communication device according to claim 5, wherein the loss rate measurement unit measures the loss rate based on the number of transmission packets and the number of retransmission request packets in the case where the number of transmission packets is larger than a total of the number of ACK packets and the number of retransmission request packets.

7. The communication device according to claim 5, wherein the packet counting unit counts a number of duplicate packets in ACK packets received by the reception unit, which is a number of the ACK packets in which information on the SACK corresponds to information on the SACK of an ACK packet received just before the ACK packet, and
the loss rate measurement unit measures the loss rate based on the number of transmission packets, the number of ACK packets, and the number of duplicate packets in the case where the number of transmission packets is smaller than a total of the number of ACK packets and the number of retransmission request packets.

8. (canceled)

9. A communication device connected to a network, comprising:
a transmission unit configured to transmit a packet to other communication device via the network;
a reception unit configured to receive, from the other communication device via the network, an ACK packet including information on a SACK and information on an ACK with respect to a packet transmitted from the transmission unit and;
a packet counting unit configured to count a number of transmission packets, which is a number of packets transmitted from the transmission unit; and
a loss rate measurement unit configured to measure a loss rate of a packet transmitted from the transmission unit in a predetermined period based on the number of transmission packets and information on the ACK and the SACK; and
a band control unit configured to control a band for transmitting a packet to the other communication device in response to a change in the loss rate, wherein
the transmission unit transmits a packet in accordance with the controlled band.

10. (canceled)

11. (canceled)

12. A packet loss rate measuring method, comprising:
measuring a loss rate of a packet transmitted from a communication device to networks;
measuring a number of transmission packets, which is a number of packets transmitted from the communication device to the network;
measuring a loss rate of a packet transmitted from the communication device to the network in a predetermined period based on the number of transmission packets and information on the SACK and an ACK included in ACK packet received by the communication device via the networks;
measuring a number of ACK packets, which is a number of ACK packets received by the communication device, and a number of duplicate packets in ACK packets received by the communication device, which is a number of ACK packets in which information on the SACK corresponds to information on the SACK of an ACK packet received just before the ACK packet; and
measuring the loss rate based on the number of transmission packets, the number of ACK packets, and the number of duplicate packets.

13. A packet loss rate measuring method, comprising:
measuring a loss rate of a packet transmitted from a communication device to a network;
measuring a number of transmission packets, which is a number of packets transmitted from the communication device to the network;
measuring a loss rate of a packet transmitted from the communication device to the network in a predetermined period based on the number of transmission packets and information on the SACK and an ACK included in an ACK packet received by the communication device via the networks; and
changing a method for measuring the loss rate in a case where the ACK packet is not returned, in a case where a SACK packet is not changed, or in a case where ACK packets are transmitted while being thinned.

14. A packet loss rate measuring method, comprising:
measuring a loss rate of a packet transmitted from a communication device to a network;
measuring a number of transmission packets, which is a number of packets transmitted from the communication device to the network;
measuring a loss rate of a packet transmitted from the communication device to the network in a predetermined period based on the number of transmission packets and information on the SACK and an ACK included in an ACK packet received by the communication device via the networks;
measuring a number of ACK packets, which is a number of ACK packets received by the communication device, and a number of retransmission request packets, which is a number of packets requested to be retransmitted in packets transmitted from the communication device, based on information on the ACK and the SACK; and
changing a method for measuring the loss rate depending on a relation among the number of transmission packets, the number of retransmission request packets, and the number of ACK packets.

15. A packet loss rate measuring method, comprising:
measuring a loss rate of a packet transmitted from a communication device to a network;
measuring a number of transmission packets, which is a number of packets transmitted from the communication device to the network;
measuring a loss rate of a packet transmitted from the communication device to the network in a predetermined period based on the number of transmission packets and information on the SACK and an ACK included in an ACK packet received by the communication device via the networks;
controlling a band for transmitting a packet from the communication device to the network in response to a change in the loss rate; and
transmitting a packet by the communication device in accordance with the controlled band.

16. The communication device according to claim 3, wherein
the packet counting unit counts a number of retransmission request packets, which is a number of packets requested to be retransmitted in packets transmitted from the transmission unit based on information on the ACK and the SACK, and
the loss rate measurement unit measures the loss rate based on the number of transmission packets and the number of retransmission request packets.

17. The communication device according to claim 4, wherein
the packet counting unit counts a number of retransmission request packets, which is a number of packets requested to be retransmitted in packets transmitted from the transmission unit based on information on the ACK and the SACK, and
the loss rate measurement unit measures the loss rate based on the number of transmission packets and the number of retransmission request packets.

18. The communication device according to claim 5, wherein
the packet counting unit counts a number of retransmission request packets, which is a number of packets requested to be retransmitted in packets transmitted from the transmission unit based on information on the ACK and the SACK, and
the loss rate measurement unit measures the loss rate based on the number of transmission packets and the number of retransmission request packets.

19. The communication device according to claim 9, wherein
the packet counting unit counts a number of retransmission request packets, which is a number of packets requested to be retransmitted in packets transmitted from the transmission unit based on information on the ACK and the SACK, and
the loss rate measurement unit measures the loss rate based on the number of transmission packets and the number of retransmission request packets.

20. The communication device according to claim 3, wherein
the packet counting unit counts a number of reception packets, which is a number of packets received by the other communication device, from a difference between information on the ACK and the SACK included in an ACK packet and information on the ACK and the SACK included in an ACK packet received by the reception unit just before the ACK packet, and
the loss rate measurement unit measures the loss rate based on the number of transmission packets and the number of reception packets.

21. The communication device according to claim 4, wherein
the packet counting unit counts a number of reception packets, which is a number of packets received by the other communication device, from a difference between information on the ACK and the SACK included in an ACK packet and information on the ACK and the SACK included in an ACK packet received by the reception unit just before the ACK packet, and
the loss rate measurement unit measures the loss rate based on the number of transmission packets and the number of reception packets.

22. The communication device according to claim 5, wherein
the packet counting unit counts a number of reception packets, which is a number of packets received by the other communication device, from a difference between information on the ACK and the SACK included in an ACK packet and information on the ACK and the SACK included in an ACK packet received by the reception unit just before the ACK packet, and
the loss rate measurement unit measures the loss rate based on the number of transmission packets and the number of reception packets.

23. The communication device according to claim 9, wherein
the packet counting unit counts a number of reception packets, which is a number of packets received by the other communication device, from a difference between information on the ACK and the SACK included in an ACK packet and information on the ACK and the SACK included in an ACK packet received by the reception unit just before the ACK packet, and
the loss rate measurement unit measures the loss rate based on the number of transmission packets and the number of reception packets.

24. The communication device according to claim 3, comprising:
measuring a number of retransmission request packets, which is a number of packets requested to be retransmitted in packets transmitted to the network, based on information on the ACK and the SACK; and
measuring the loss rate based on the number of transmission packets and the number of retransmission request packets.

25. The communication device according to claim 4, comprising:
measuring a number of retransmission request packets, which is a number of packets requested to be retransmitted in packets transmitted to the network, based on information on the ACK and the SACK; and
measuring the loss rate based on the number of transmission packets and the number of retransmission request packets.

26. The communication device according to claim 5, comprising:
measuring a number of retransmission request packets, which is a number of packets requested to be retransmitted in packets transmitted to the network, based on information on the ACK and the SACK; and
measuring the loss rate based on the number of transmission packets and the number of retransmission request packets.

27. The communication device according to claim 9, comprising:
measuring a number of retransmission request packets, which is a number of packets requested to be retransmitted in packets transmitted to the network, based on information on the ACK and the SACK; and
measuring the loss rate based on the number of transmission packets and the number of retransmission request packets.
